(19) United States
(12) Patent Application Publication
(10) Pub. No.: US 2024/0044088 A1
(43) Pub. Date: Feb. 8, 2024

(54) VIBRATING ROLLER

(71) Applicant: AMMANN SCHWEIZ AG, Langenthal (CH)

(72) Inventor: Radko NOVOTNÝ, Nové Mesto nad Metují (CZ)

(73) Assignee: AMMANN SCHWEIZ AG, Langenthal (CH)

(21) Appl. No.: 18/257,620

(22) PCT Filed: Dec. 11, 2021
(86) PCT No.: PCT/EP2021/025492

§ 371 Date: Jun. 15, 2023

(30) Foreign Application Priority Data
Dec. 18, 2020 (CZ) PV 2020-693

(51) Int. Cl. E01C 19/28

(52) U.S. Cl. CPC E01C 19/286; E01C 19/282

(57) ABSTRACT

A vibrating roller, specifically a self-propelled vibrating roller includes a vibrating tread mounted by means of a damping system in the frame of an earthmoving construction machine. Within the cavity of the vibrating tread internal mechanisms are arranged, which are specifically a vibrating mechanism and a drive mechanism. At least one internal mechanism in the vibrating tread is mounted in the inner frame, which is mounted asymmetrically in the vibrating tread to the axis of the vibrating roller perpendicular to the axis of its rotation. The internal mechanisms are mounted in the axis of rotation of the vibrating roller. The vibrating mechanism includes a vibration motor and a drive mechanism including a travel motor, with the vibrating mechanism being connected to a vibrating shaft which includes a weight.

### TECHNICAL FIELD

The invention relates to a vibrating roller for earthmoving construction machinery, in particular to its travel drive and vibration drive.

### STATE OF THE ART

A number of structural solutions of vibrating rollers of earthmoving construction machines are known from current technology, which are used for compacting subsoil and are used, for example, for compacting freshly laid asphalt, soil and other compact-able materials. Earthmoving machines for subsoil compaction always have at least one rotating roller which compacts the subsoil by passing it over it. To increase the efficiency of compaction, the vibrating rollers are provided with a vibrating mechanism acting on the rotating roller. The vibrating mechanisms usually comprise of eccentrically arranged weights placed on a rotating shaft which is inside the rotating roller.

With respect to vibrating roller drives, hydraulic motors are most often used for both vibration drive and travel drive. The use of hydraulic motors is known, for example, from patent documents WO 20181300262 and CZ 304008.

From patent document WO 2020200509 is known the use of electric motors in the construction of vibrating rollers as well. However, this use is only described here in general terms, without a detailed indication of a specific design. The reason is evidently that the use of an electric motor to drive the mechanisms of vibratory rollers brings with it one major disadvantage in the form of larger installation dimensions compared to a hydraulic motor. This disadvantage is manifested especially in cylinders with smaller dimensions, where there are cramped conditions for the placement of this drive.

Its disadvantages are known from the above-mentioned state of current technology, which in the use of hydraulic motors is a relatively complicated design with the need for using internal combustion engines to provide pressurised oil for their propulsion, which brings with it a considerable burden on the environment. Whereas the use of electric motors brings minimal environmental impact, with the big disadvantage being the technical problem of how to place large electric motors in the relatively very small inner space of the roller, all the while maintaining its full functionality.

The object of the invention is the design of a vibrating roller which will enable the use of vibration and travel drives with larger installation dimensions, while also using electric motors.

### Principle of the Invention

The above-mentioned disadvantages are largely eliminated and the objectives of the invention are fulfilled by a vibrating roller, specifically a self-propelled vibrating roller comprising a vibrating tread mounted by means of a damping system in the frame of a construction machine where internal mechanisms are arranged within the cavity of the vibrating tread, which are specifically a vibrating mechanism and a drive mechanism which, according to the invention is characterised by that at least one internal mechanism is mounted in the vibrating tread within the inner frame which is mounted in the vibrating tread asymmetrically to the axis of the vibrating roller perpendicular to the axis of its rotation, with the internal mechanisms being mounted in the axis of rotation of the vibrating roller. The vibration mechanism including a vibration motor, and the drive mechanism including a travel motor, and with the vibration mechanism being coupled to a vibration shaft containing a weight. The advantage is that the asymmetrical arrangement of the internal mechanisms allows a much more advantageous use of the internal space of the vibrating roller, thus allowing the installation of larger drives such as electric motors. With further advantages being the possibility of precise and efficient placement of individual parts arranged within the cavity of the vibrating cylinder, the possibility of easier balancing of the entire system and, the simplicity of the overall design of the drives.

It is to advantage if the vibrating mechanism is connected to the vibrating shaft via a coupling. This allows for the reliable generation of vibrations.

It is to further advantage if the vibrating shaft is mounted by means of bearings in the inner frame.

To advantage, a gearbox is attached to the travel motor which is rotatably connected to the vibrating tread.

It is to further advantage if the electric drive motor is connected to a gearbox.

It is also to advantage if the vibrating mechanism comprises a bearing housing which is dynamically balanced with the vibrating shaft. The advantage is stable and fail-safe operation of the vibrating mechanism.

It is to advantage if the vibrating shaft comprises a weight which is positioned in such a way that the eccentric force is at the centre of gravity of the vibrating tread. The advantage is the possibility of simple balancing of the entire vibration system.

It is to further advantage if the vibrating mechanism is rotatably mounted in the vibrating tread.

The invention solves the technical problem connected with placing bulky electric motors within the relatively small inner space of a roller, all the while maintaining its full functionality. The main advantage is that the asymmetrical arrangement of the internal mechanisms allows for a much more advantageous placement of large drives. To advantage, this is specifically ensured by the asymmetrical mounting of the vibrating mechanism within the vibrating roller. This mounting allows the installation of larger electric motors, both to drive the vibrator and to move the roller, so that it does not exceed the outer dimension of the reel of the vibrating roller. The use of the invention is particularly advantageous for light tandem rollers, where it is advantageous to use a fully electrified solution for use in congested urban areas and underground garages.

### OVERVIEW OF THE FIGURES

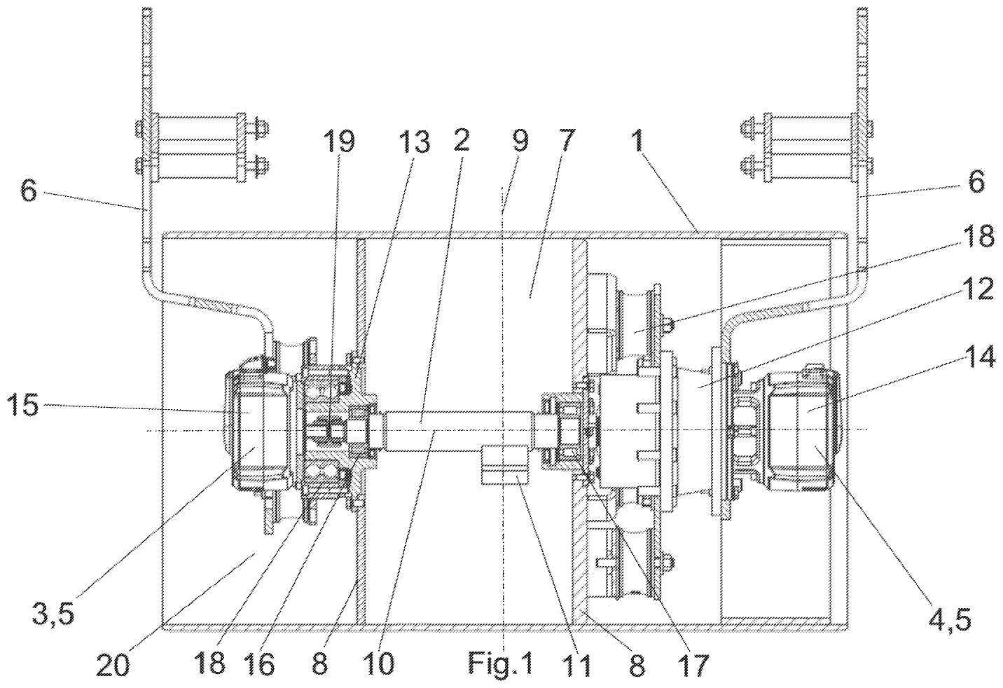

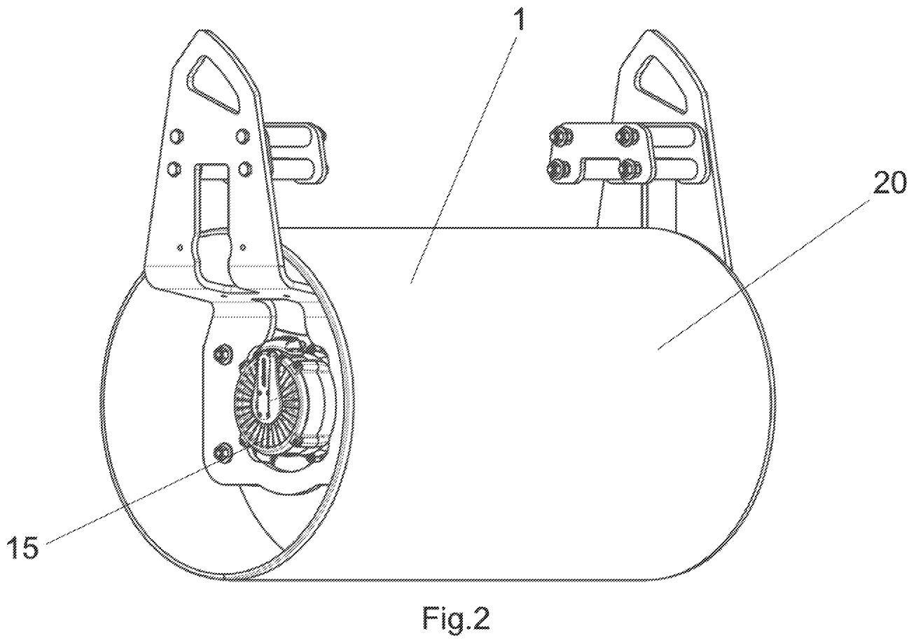

The invention will be further elucidated using drawings, in which FIG. 1 shows a cross-sectional view of the overall arrangement of the vibrating roller and FIG. 2 shows a three dimensional view of the entire vibrating roller.

### EXAMPLES OF THE PERFORMANCE OF THE INVENTION

The self-propelled vibrating roller (FIG. 1, FIG. 2) comprises a vibrating tread 1 mounted by means of a damping system 18 of a frame 6 of a earthmoving construction machine.

Arranged in the cavity 7 of the vibrating tread 1 are internal mechanisms 5, which are a vibrating mechanism 3 and a drive mechanism 4.

The internal mechanisms 5 are mounted in the axis 10 of rotation of the vibrating roller 20, being mounted in the inner frame 8, which is mounted in the vibrating tread 1 asymmetrically to the axis 9 and perpendicular to the axis 10 of rotation.

The vibration mechanism 3 comprises a vibration motor 15, which is an electric motor. The vibrating mechanism 3 is connected by means of a coupling 19 to a vibrating shaft 2, which is mounted in bearings 16, 17 within the inner frame 8.

The drive mechanism 4 comprises a travel motor 14, which is an electric drive motor. Attached to the travel motor 14, more precisely to its body, is a gearbox 12 of the reduction unit, which is rotatably connected to the vibrating drum 1 by means of a bearing (not shown).

The electric drive motor is connected by its rotary output (not shown) to the gearbox, which is a reduction unit.

The vibrating mechanism 3 comprises a bearing housing 13 which is dynamically balanced with the vibrating shaft 2.

The vibrating shaft 2 comprises a weight 11, which is positioned so that the eccentric force is located at the centre of gravity of the vibrating tread 1.

The vibrating mechanism 3 is rotatably mounted within the vibrating tread 1.

### INDUSTRIAL APPLICATION

The vibrating roller according to the invention can be used on earthmoving construction machines, specifically on earthmoving construction machines in which the hydraulic motors of drive or vibration are replaced by electric motors.

### LIST OF REFERENCE MARKS

1 vibrating tread
2 vibrating shaft
3 vibrating mechanism
4 drive mechanism
5 internal mechanism
6 frame of earth moving construction machine
7 cavity of the vibrating tread
8 inner frame
9 axis perpendicular to the axis of rotation
10 axis of rotation
11 weight
12 gearbox
13 bearing housing
14 travel motor
15 vibration motor
16 bearing I
17 bearing II
18 damping system
19 clutch
20 vibrating roller

1. A vibrating roller, in particular a self-propelled vibrating roller comprising a vibrating tread mounted by means of a damping system in the frame of a earthmoving construction machine, where arranged within the cavity of the vibrating tread are internal mechanisms which are specifically a vibrating mechanism and a drive mechanism, characterised by that at least one internal mechanism is mounted within the vibrating tread in the inner frame which is mounted in the vibrating tread asymmetrically to the axis of the vibrating roller perpendicular to the axis of its rotation, with the inner mechanisms being mounted in the axis of rotation of the vibrating roller, the vibrating mechanism containing a vibration motor, and a drive mechanism including a travel motor, with the vibrating mechanism being connected to a vibrating shaft which contains a weight.

2. The vibrating roller according to claim 1, characterised by that the vibrating mechanism is connected to the vibrating shaft by means of a coupling.

3. The vibrating roller according to claim 1, characterised by that mounted in bearings within the inner frame is the vibrating shaft.

4. The vibrating roller according to claim 1, characterised by that the vibration motor is an electric motor.

5. The vibrating according to claim 1, characterised by that the travel motor is an electric drive motor.

6. The vibrating roller according to claim 1, characterised by that a gearbox is attached to the travel motor and is rotatably connected to the vibrating tread.

7. The vibrating roller according to claim 5, characterised by that the electric drive motor is connected to a gearbox.

8. The vibrating roller according to claim 1, characterised by that the vibrating mechanism comprises a bearing housing which is dynamically balanced with the vibrating shaft.

9. The vibrating roller according to claim 1, characterised by that the vibrating shaft comprises a weight which is positioned in such a way that the eccentric force is at the centre of gravity of the vibrating tread.

10. The vibrating roller according to claim 1, characterised by that the vibrating mechanism is rotatably mounted in the vibrating tread.
